(19) United States
(12) Patent Application Publication
(10) Pub. No.: US 2009/0001189 A1
(43) Pub. Date: Jan. 1, 2009

(54) FLUID DISCHARGING APPARATUS AND FLUID DISCHARGING METHOD

(75) Inventor: Eiichiro WATANABE, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/163,800

(22) Filed: Jun. 27, 2008

(30) Foreign Application Priority Data
Jun. 29, 2007 (JP) 2007-172809

(51) Int. Cl. B05B 17/04

(52) U.S. Cl. 239/11; 239/302

(57) ABSTRACT

A fluid discharging apparatus comprising a head including nozzles for discharging fluid, a storage for storing the fluid to be supplied to the head, a pressurizing unit that pressurizes the fluid so that the fluid flows from the storage toward the head, and a receiving unit for receiving the fluid discharged from the nozzles when being positioned at a position opposing the nozzles wherein the receiving unit does not contact the nozzles.

### CROSS-REFERENCE TO RELATED APPLICATIONS

This application claims the benefit of Japanese Patent Application No. 2007-172809, filed Jun. 29, 2007, which is expressly incorporated herein by reference in its entirety.

### BACKGROUND OF THE INVENTION

1. Technical Field

The present invention relates to a fluid discharging apparatus and a fluid discharging method.

2. Related Art

An inkjet printer is an example of a known fluid discharging device that performs a printing process by discharging a fluid (ink) on various media such as paper, cloth, or film. This fluid discharging apparatus includes a head having nozzles for discharging the fluid and a storage for storing the fluid supplied to the head, and is configured in such a manner that the fluid supplied from the storage to the head is discharged from the nozzles.

In the fluid discharging apparatus, when the nozzles become clogged by the fluid, a cleaning operation is performed to remove any clogs. In one cleaning operation known in the related art, such as the system described in Japanese Patent No. JP-A-2005-53119, the clogged fluid is collected by using a suction member to suck the fluid from the nozzles when the nozzles are sealed by a sealing member or cap.

However, in some cases, the sealing member cannot seal the nozzles adequately. For example, when the nozzles are arranged in a large area, the size of the sealing member is increased accordingly. When the sealing member is large, the accuracy of the fit between the shape of the sealing member and nozzles is likely to be lowered, and hence part of the sealing member may not be able to seal the nozzles. This causes the sucking efficiency of the fluid of the suction member to be lowered. Therefore, there is a risk of inadequately collecting the fluid which has caused the clogging.

### BRIEF SUMMARY OF THE INVENTION

An advantage of some aspects of the invention is that fluid is effectively collected from nozzles during a cleaning process.

One aspect of the invention comprises a fluid discharging apparatus including: a head having a plurality of nozzles for discharging fluid, a storage for storing the fluid to be supplied to the head, a pressurizing unit for pressurizing the fluid so that the fluid flows from the storage toward the head; and a receiving unit capable of receiving the fluid pressurized by the pressurizing unit and discharged from the nozzles when being positioned at a position opposing the nozzles that does not contact the nozzles.

Other features of the invention will be apparent by description in this specification and the attached drawings

### BRIEF DESCRIPTION OF THE DRAWINGS

The invention will be described with reference to the accompanying drawings, wherein like numbers reference like elements.

FIG. 1 is a general configuration block diagram of a printer 1, illustrating an embodiment of the invention;

FIG. 2A is a cross-sectional view of the printer;

FIG. 2B is illustrates the process by which the printer feeds a sheet of paper through the printer;

FIG. 3 is a diagram showing an arrangement of nozzles on a lower surface of a head;

FIG. 4A is a pattern diagram showing a state in which a printing process is being performed and an ink receiver positioned at a waiting position;

FIG. 4B is a pattern diagram showing a state in which the ink receiver is positioned at a cleaning position in order to receive ink discharged from the nozzles;

FIGS. 5A and 5B illustrate a state in which the ink receiver 25 receives ink discharged from nozzle rows during a cleaning process;

FIG. 6 is a flowchart illustrating a method of performing a cleaning process;

FIGS. 7A and 7B are drawings illustrating the ink receiver receiving ink discharged from nozzle rows during a cleaning process; and

FIG. 8 is a drawing showing another embodiment of a head unit.

### DESCRIPTION OF EXEMPLARY EMBODIMENTS

In order to clarify the configuration and the operation of the invention, various embodiments of a fluid ejecting apparatus according to the principles of the present invention will be described. In an exemplary embodiment, an ink jet printer, which is an example of a fluid ejecting apparatus, will be described.

### Line Head Printer

Assuming that the fluid discharging apparatus is an inkjet printer, a configuration of a printer 1 and a printing process will be described taking a line head printer (hereinafter, referred to simply as printer 1) as an example of an inkjet printer.

### Configuration of Printer 1

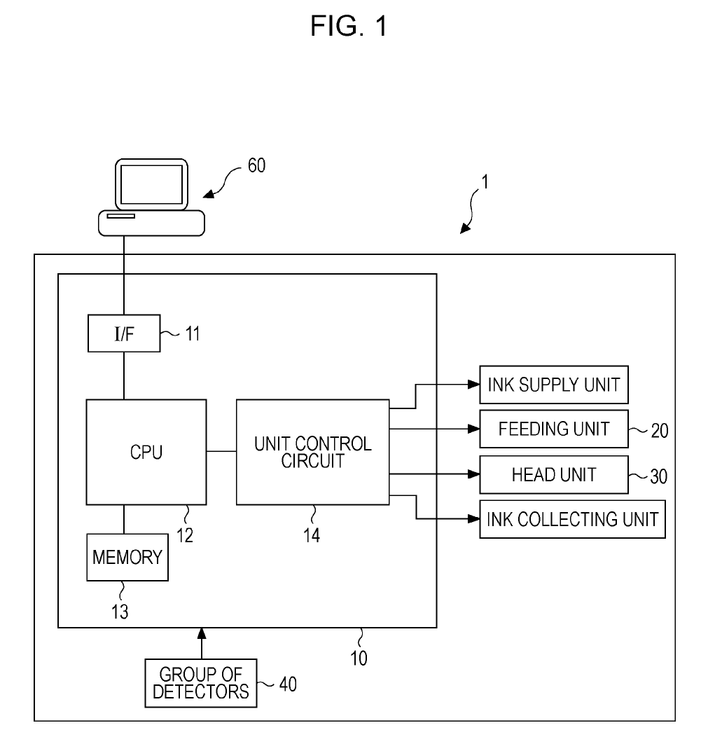

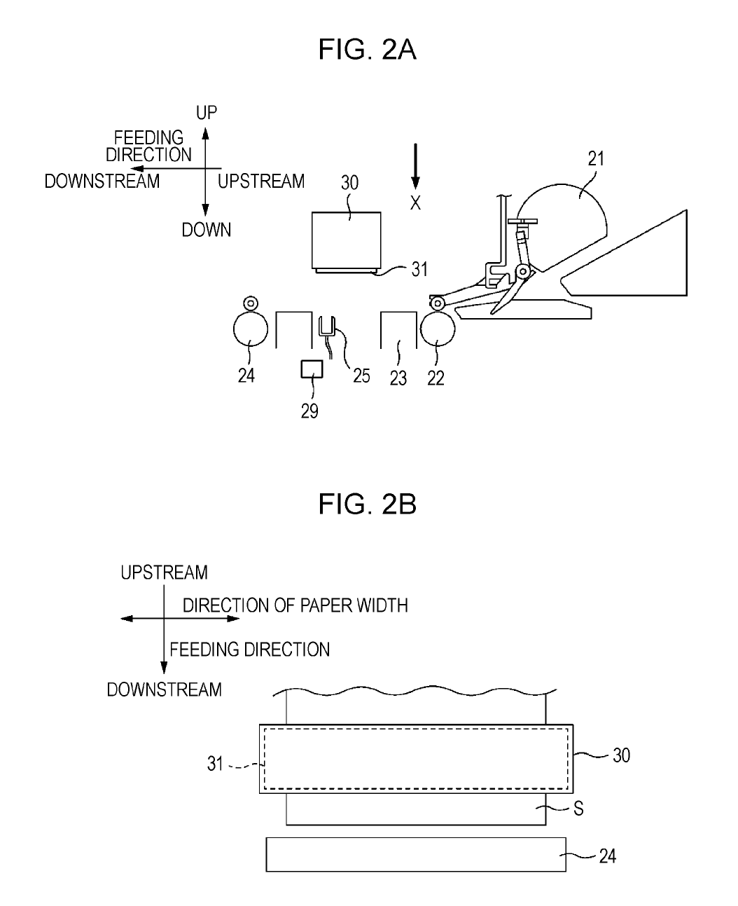

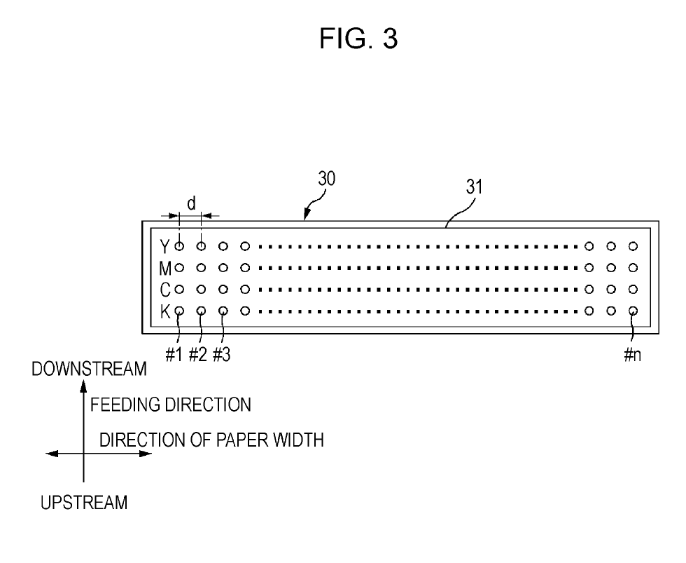

Referring now to FIG. 1, FIG. 2A, FIG. 2B and FIG. 3, the configuration of the printer 1 will be described. FIG. 1 is a general configuration block diagram of the printer 1 in one embodiment of the invention. FIG. 2A is a cross-sectional view of the printer 1. FIG. 2B is a drawing showing a state in which the printer 1 feeds a sheet S through the printer 1. FIG. 3 is a pattern diagram showing arrangement of nozzles on a lower surface of a head 31. FIG. 2B is a drawing of a head unit 30 as viewed from the X shown in FIG. 2A.

The printer 1 receives print data from a computer 60 which acts as an external apparatus that is capable of controlling the respective units (a feeding unit 20, the head unit 30, an so on) using a controller 10. The printer 1 uses the print data to form an image on the sheet S. A group of detectors 40 monitor the state in the printer 1 and the controller 10 controls the respective units on the based on the result of detection.

The controller 10 is a control unit for controlling the printer 1. An interface unit 11 is a device for receiving and transmitting data between the computer 60 as the external apparatus and the printer 1. A CPU 12 is an arithmetic processing unit for controlling the printer 1. A memory 13 is a device for storing programs of the CPU 12. The CPU 12 controls the respective units by a unit control circuit 14 according to the programs stored in the memory 13.

The feeding unit 20 feeds the sheet S to a printable position by feeding the sheet S a predetermined feeding amount in the feeding direction at the time of printing. The feeding unit 20 includes a paper feeding roller 21, a feeding roller 22, a platen 23 and a paper discharge roller 24 as shown in FIG. 2A. The feeding roller 22 is a roller for feeding sheets S inserted into a sheet insertion port into the printer 1. The feeding roller 22 is a roller for feeding the sheet S fed by the paper feeding roller 21 to a printable area. The platen 23 supports the sheet S being printed. The paper discharge roller 24 is a roller for discharging the sheet S to the outside the printer 1.

The head unit 30 is a device for discharging a fluid ink onto the sheet S. The head unit 30 discharges the ink onto the sheet S being fed through the printer 1 in order to form dots on the sheet S, which form an image on the sheet S. The head unit 30 in this embodiment is able to simultaneously form dots along the width of the sheet.

The head unit 30 includes the head 31. The head 31 is formed with four nozzle rows as shown in FIG. 3, that is, a black ink nozzle row (nozzle row K), a cyan ink nozzle row (nozzle row C), a magenta ink nozzle row (nozzle row M) and a yellow ink nozzle row (nozzle row Y). The each nozzle row includes a plurality (n) of nozzles arranged in a row at regular distances d along the width of the sheet. The nozzles are designated by numbers in ascending order from the left to the right (#1 to #n). The each nozzle is provided with a pressure chamber (not shown) and a drive element (piezoelectric element) capable of changing the capacity of the pressure chamber and allowing the ink to be discharged.

### Printing Process

A printing process of the printer 1 having the configuration as described above will be described. The controller 10, upon reception of a print command and print data from the computer 60, analyzes contents of various commands included in the print data and carries out the following process using the respective units.

The controller 10 rotates the paper feeding roller 21, and feeds the sheet S to be printed into the printer 1. The controller 10 then rotates the feeding roller 22, and positions the fed sheet S at a print start position. At this time, the sheet S opposes at least part of nozzles of the head 31.

Subsequently, the sheet S is fed at a constant velocity by the feeding roller 22 while it passes under the head 31 (over the platen 23). While the sheet S passes under the head 31, ink is intermittently discharged from each nozzle, so as to form a series of dot lines (raster lines) including a plurality of dots along the feeding direction on the sheet S. Finally, the controller 10 discharges the sheet S via the paper discharge roller 24 after having completed the printing of an image.

### Configuration of Ink Supply Unit and Ink Collecting Unit

In the printer 1, since the amount of ink in the head 31 is reduced as a result of the printing process, ink needs to be supplied to the head 31. Additionally, as ink is discharged from the nozzles of the head 31 during the cleaning processes, the ink needs to be replaced. Therefore, the printer 1 supplies ink from an ink cartridge 35 to the head 31, and collects the ink discharged from the nozzles and collected by the ink receiver 25 during the cleaning process.

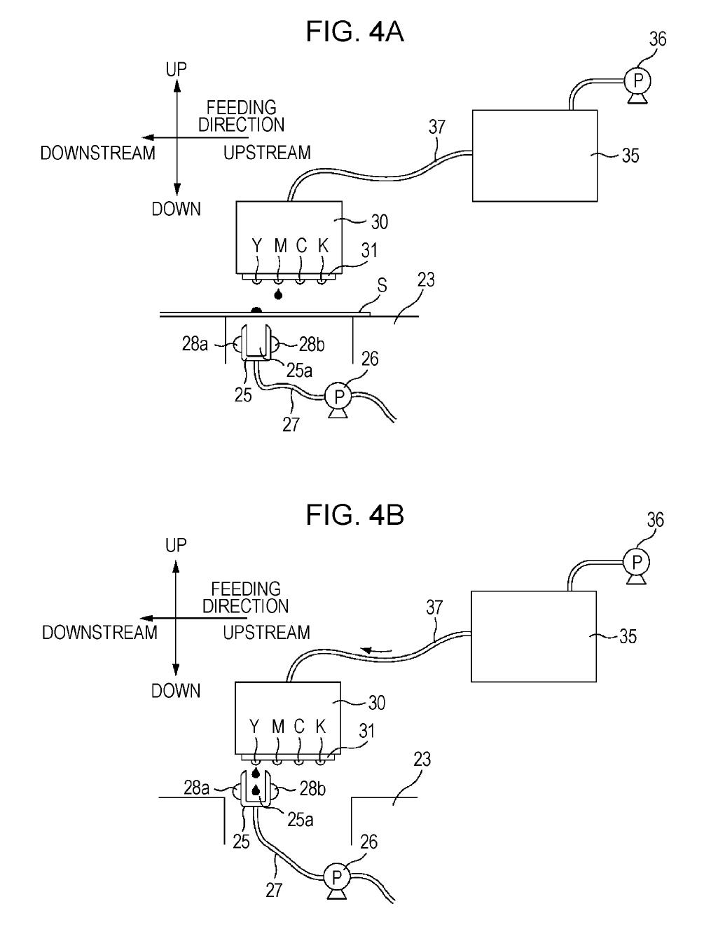

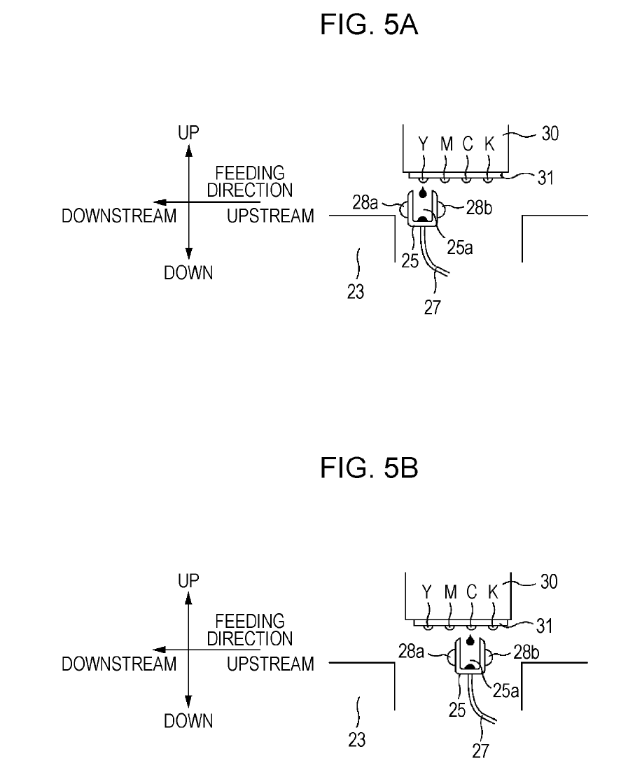

Accordingly, referring to FIG. 4A, FIG. 4B, FIG. 5A and FIG. 5B, configurations of an ink supply unit and an ink collecting unit shown in FIG. 1 will be described below. FIG. 4A is a pattern diagram showing the state in which the printing process is being carried out with the ink receiver 25 positioned at a waiting position. FIG. 4B is a pattern diagram showing a state in which the ink receiver 25 positioned at a cleaning position wherein the ink receiver 25 receives ink discharged from the nozzles. FIG. 5A is a drawing showing a state in which the ink receiver 25 receives ink discharged from the nozzle row Y during a cleaning process. FIG. 5B is a drawing showing a state in which the ink receiver 25 receives ink discharged from the nozzle row C during a cleaning process.

The printer 1 includes the ink cartridge 35 for storing ink to be supplied to the head 31. An ink cartridge 35 is provided for each color. For example, yellow ink is supplied from the ink cartridge 35 which stores yellow ink to the yellow nozzle row Y.

A pressurizing pump 36 which comprises a pressurizing unit for pressurizing ink is stored near the ink cartridge 35 during a cleaning process. More specifically, the pressurizing pump 36 pressurizes a pack having ink stored therein which is provided in the ink cartridge 35. When the pressurizing pump 36 pressurizes the pack, the pack is compressed. Consequently, ink in the pack is also pressurized and directed from the ink cartridge 35 to the head 31. Then, the ink pressurized by the pressurizing pump 36 forcedly flows from the ink cartridge 35 to the head 31 via a tube 37.

During the printing process, the pressurizing pump 36 does not pressurize ink. This is because the ink cartridge 35 is positioned above the head 31 in the vertical direction as shown in FIG. 4A, and hence the ink stored in the ink cartridge 35 flows toward the head 31 due to the pressure difference. The amount of consumption of ink during the printing process is relatively small when compared to the amount of time the printing process takes, so it is not necessary to force the flow and supply of ink.

As a configuration of ink collection, the printer 1 includes an ink receiver 25 for receiving ink discharged from the nozzles. The ink receiver 25 is a metallic groove having a groove 25a. The longitudinal direction of the groove 25a extends along the direction of the width of the sheet, so that the groove 25a opposes the nozzles of the nozzle row. The ink receiver 25 is provided below the head 31 in the vertical direction, and is shifted between the waiting position shown in FIG. 4A and the cleaning position shown in FIG. 4B.

The cleaning position here is a position where the ink receiver 25 receives ink discharged from the nozzle rows that face the ink receiver 25 during the cleaning process. The ink receiver 25 receives ink pressurized by the pressurizing pump 36 and discharged from the nozzle rows when the ink receiver 25 is at the cleaning position. Since the distance between the ink receiver 25 from the nozzles is extremely small during the cleaning process (this distance has been enlarged for purposes of clarity in FIG. 4B), the discharged ink is reliably collected by ink receiver 25. The waiting position is a position which is farther from the nozzle rows than the cleaning position in the vertical direction. The waiting position is a position below the sheet S so as not to hinder the feeding of the sheet S during the printing process.

The ink receiver 25 positioned at the cleaning position is configured to be movable in the feeding direction so as to oppose any one of the four nozzle rows arranged in the feeding direction which intersects the vertical direction while maintaining the position in the vertical direction. The ink receiver 25 then opposes one of the four nozzle rows without contacting the nozzle rows, and receives ink pressurized by the pressurizing pump 36 and discharged from the nozzle row.

The printer 1 includes a suction pump 26 which acts as a suction member for sucking ink received by the ink receiver 25 positioned at the cleaning position. By being sucked by the suction pump 26, ink in the ink receiver 25 flows through a tube 27, and is stored in a reservoir (not shown) which is connected to the tube 27 on the downstream side of the suction pump 26. Accordingly, the ink causing the clogging is collected in the reservoir.

The shift of the ink receiver 25 between the waiting position and the cleaning position in the vertical direction is carried out by a vertical mechanism 28a provided on the ink receiver 25. More specifically, by operating the vertical mechanism 28a, which may comprise, for example, a cam, using a drive force from a motor 29, the ink receiver 25 is shifted in the vertical direction and is selectively positioned between the waiting position and the cleaning position.

The shift of the ink receiver 25 positioned at the cleaning position in the vertical direction in the feeding direction is carried out by a feeding-direction shifting mechanism 28b, which comprises a second shifting mechanism in the claims below, provided on the ink receiver 25. More specifically, by operating the feeding-direction shifting mechanism 28b, which may also comprise a cam, by applying a drive force from the motor 29, the ink receiver 25 is shifted in the feeding direction so as to selectively oppose one of the four nozzle rows.

The vertical mechanism 28a and the feeding-direction shifting mechanism 28b are not limited to the configuration as described above, a rack and a pinion may be used instead of a cam. The suction pump 26 has been exemplified as the suction member, it is not limited thereto, and may be a cylinder and a piston.

### Cleaning Control

When the viscosity of ink at the nozzles is increased due to evaporation during long periods of rest, the nozzles may become clogged. In order to solve this process, the printer 1 according to this embodiment carries out a cleaning process described below. The cleaning control is mainly characterized by (1) shifting the ink receiver 25 positioned at the waiting position with respect to the head 31 to the cleaning position and (2) pressurizing the ink directed from the ink cartridge 35 to the head 31 for causing the ink receiver 25 positioned at the cleaning position to receive the ink and causing the nozzle to discharge the ink.

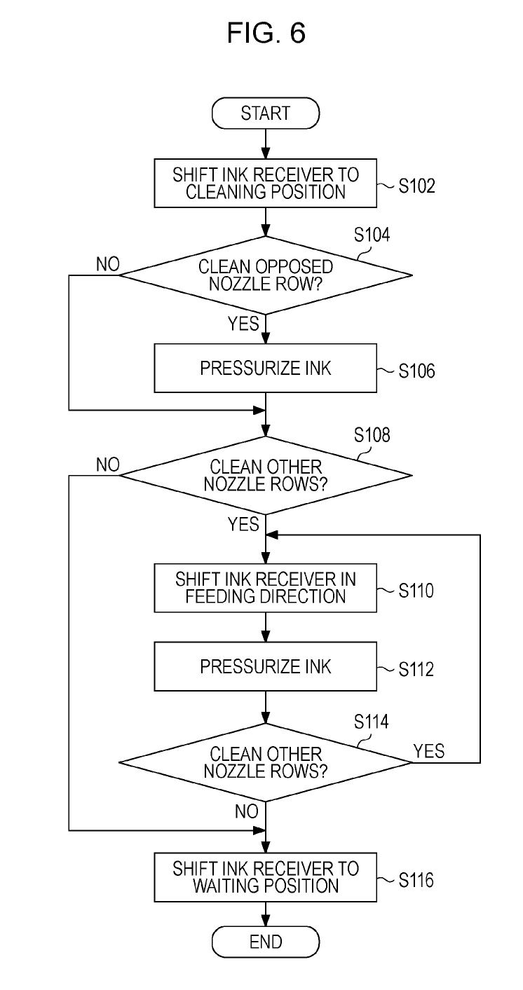

FIG. 6 is a flowchart for explaining the cleaning control in this embodiment. This cleaning control is carried out immediately after the power of the printer 1 is turned on by a user or the like and before the printing process is performed.

The various operations of the printer 1 when this control is carried out are mainly controlled by the controller 10. In particular, in this embodiment, it is realized by the CPU 12 processing a program stored in the memory 13. This program includes codes for causing various operations as described below to be performed.

The controller 10 first shifts the ink receiver 25 positioned at the waiting position (FIG. 4A) to the cleaning position (FIG. 4B) by driving the vertical shifting mechanism 28a (Step S102). At this time, the ink receiver 25 is positioned at the cleaning position opposite the nozzle row Y so as not to contact nozzle row Y.

Subsequently, if a cleaning process is performed the nozzle row Y (Step S104: Yes), the controller 10 causes the pressurizing pump 36 to pressurize the yellow ink for a predetermined time (Step S106). The yellow ink is pressurized by the pressurizing pump 36 so as to be directed from the ink cartridge 35 to the head 31, where it is forcedly discharged from the nozzle row Y (shown in FIG. 3) At this time, the ink which has caused the clogging is also discharged together. The discharged ink is received by the ink receiver 25. Accordingly, the ink which has caused the clogging of the nozzle row Y is removed.

Subsequently, the system determines if the other nozzle rows (nozzle row M, nozzle row C and nozzle row K) need to be cleaned (Step S108). If so, the controller 10 shifts the ink receiver 25 in the feeding direction by the feeding-direction shifting member 28b (Step S110). The ink receiver 25 is shifted in the feeding direction so as to oppose the appropriate nozzle row M, nozzle row C or nozzle row K. It is assumed here that the ink receiver 25 opposes the nozzle row C as shown in FIG. 5B. Then, the controller 10 causes the pressurizing pump 36 to pressurize cyan ink for a predetermined time (Step S112). The cyan ink is pressurized and is forcedly discharged from the nozzle row C (as shown in FIG. 3), and the discharged ink is received by the ink receiver 25. Accordingly, the ink which has clogged the nozzle row C is removed.

When further cleaning other nozzle rows (Step S114: YES), as described above, the Steps S110 and S112 are repeated for each nozzle rows that needs cleaning. In this manner, in this embodiment, a cleaning process is carried out independently for each nozzle row.

During the cleaning process, the controller 10 activates the suction pump 26 (FIG. 4B) to suck the ink received by the ink receiver 25. Accordingly, the ink in the ink receiver 25 flows into the reservoir through the tube 27. Therefore, the ink does not accumulate in the ink receiver 25.

In contrast, when there is no nozzle row that needs to be cleaned (Step S114: No), the controller 10 causes the ink receiver 25 to oppose the nozzle row Y by the feeding-direction shifting mechanism 28b, and then shifts the ink receiver 25 to the waiting position by the vertical mechanism 28a (Step S116). Accordingly, the cleaning process ends.

The cleaning process described above has been described as being carried out immediately after the power of the printer 1 is turned on, but the invention is not limited thereto. For example, when the time period in which the nozzles do not discharge ink continuously exceeds a predetermined time, the above-described cleaning control may be performed.

Although the vertical mechanism 28a has been described as being provided on the ink receiver 25, it may be provided on the head 31. In such a case, the ink receiver 25 is not shifted in the vertical direction, but the head 31 is shifted in the vertical direction by the vertical mechanism 28a, so that the ink receiver 25 is selectively positioned at the waiting position and the cleaning position. Therefore, the vertical mechanism 28a may shift the head 31 and the ink receiver 25 with respect to each other so that the ink receiver 25 is positioned at the cleaning position or the waiting position.

Effectiveness of Printer 1 in this Embodiment

As described above, the printer 1 in this embodiment includes (1) the pressurizing pump 36 for pressurizing ink so that ink is directed from the ink cartridge 35 toward the head 31 and (2) the ink receiver 25 for receiving the ink pressurized by the pressurizing pump 36 and discharged from the nozzles when the ink receiver 25 is positioned at the cleaning position opposing the nozzles without contacting the nozzles Accordingly, the ink is collected effectively from the nozzles at the time of cleaning.

In other words, when the pressurizing pump 36 is provided, ink is pressurized so that the ink forcedly flows from the ink cartridge 35 to the head 31. Therefore, the pressurized ink is discharged from the nozzles, and the ink which has caused the clogging of the nozzles is discharged. Consequently, the ink is eliminated from the nozzles. By the ink receiver 25 receiving the ink when it is positioned near the nozzle at the cleaning position without actually touching the nozzle, the ink discharged from the nozzle may be collected effectively without hindering the ink from being discharged from the nozzle.

On the other hand, in the related art, although the ink which has caused the clogging is collected by using a suction member (suction pump) to suck ink in the nozzles in while the nozzles are sealed by a cap, when the seal by the cap is inadequate, the ink cannot be collected effectively. More particularly, in the line head printer (printer 1) described above, the nozzles are arranged in a wider range than in serial printers, meaning that the size of the cap increases. When the cap is large, the shape accuracy of the cap (for example, the accuracy of the straightness) is likely to be lowered, and hence part of the cap may not seal the nozzle. When the sealing of the cap is inadequate, the sucking efficiency of ink by the suction member is also lowered, so that the ink which has caused the clogging cannot be collected effectively.

Thus, the clogged nozzles may be effectively unclogged during a cleaning operation with a simple configuration without providing the sealing member.

### Second Embodiment

In the embodiment (first embodiment) shown above, the feeding-direction shifting mechanism 28b is provided on the ink receiver 25. However, the feeding-direction shifting mechanism 28b may be provided on the head 31 as in a second embodiment described below.

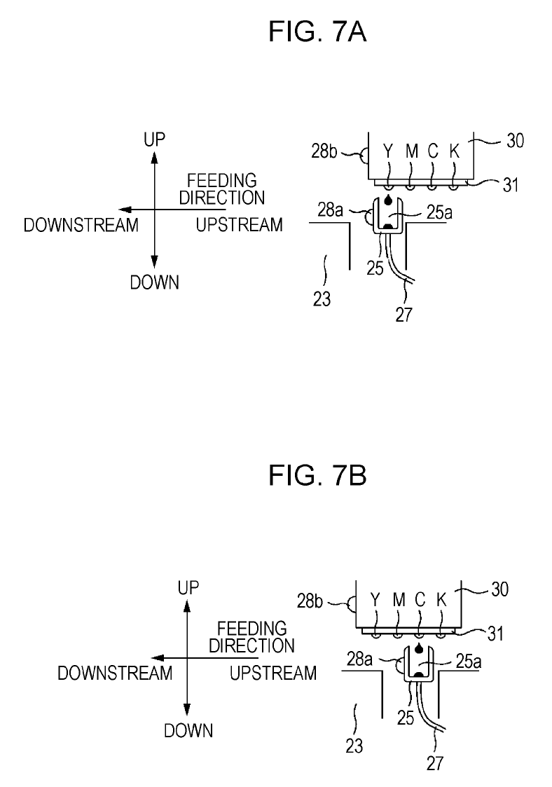

FIG. 7A is a drawing showing a state in which the ink receiver 25 receives ink discharged from nozzle row Y during the cleaning process. FIG. 7B is a drawing showing a state in which the ink receiver 25 receives ink discharged from the nozzle row C during the cleaning process.

The ink receiver 25 according to the second embodiment receives ink pressurized by the pressurizing pump 36 at the cleaning position and discharged from the nozzle rows as in the first embodiment. On the other hand, the ink receiver 25 in the second embodiment is different from that in the first embodiment in that the feeding-direction shifting mechanism 28b is not provided and the ink receiver 25 is not shifted in the feeding direction. Instead, the feeding-direction shifting mechanism 28b is provided on the head 31, and the head 31 is shifted in the feeding direction. In such a case, one of the four nozzle rows of the head 31 shifted by the feeding-direction shifting mechanism 28b in the feeding direction opposes the ink receiver 25 (see FIG. 7A and FIG. 7B). Then, the ink receiver 25 receives ink which is discharged from the opposing nozzle row.

In this manner, the feeding-direction shifting mechanism 28b may shift the head 31 and the ink receiver 25 with respect to each other in the feeding direction so that the ink receiver 25 selectively opposes any one of the four nozzle rows.

In the case of the printer 1 according to the second embodiment, since the space for shifting the ink receiver 25 in the feeding direction is not necessary, the configuration of the platen 23 may be effectively downsized. Since the ink receiver 25 and the head 31 are shifted independently, the time required for cleaning may be reduced in comparison with the case in which the ink receiver 25 is moved in the vertical direction and in the feeding direction. The configurations which have not been described in the second embodiment are the same as the configurations in the first embodiment.

### Other Embodiments

Although the fluid discharging apparatus according to an aspect of the invention has been described on the basis of the embodiments described above, the embodiments shown above are given just for facilitating understanding of the invention and are not intended to limit the invention. The invention may be modified or altered without departing from the scope of the inventions and the equivalents are also included in the invention.

Although the fluid discharging apparatus is embodied in the inkjet printer in the embodiment described above, the invention is not limited thereto, and may be embodied in a fluid discharging apparatus in which fluids other than ink (such as liquid, liquid-state substances in which particles of functional material are dispersed therein, fluidal material such as gel and solid state which can be flowed and discharged as fluid are included) are injected or discharged. For example, the apparatus may be a liquid state substance discharging apparatus for discharging liquid state substance containing materials such as electrode materials or color materials used for manufacturing liquid crystal displays, EL (electroluminescence) displays and surface emitting displays in the dispersed or dissolved form, a liquid discharging apparatus for discharging biological organic substances used for manufacturing biochips, or a liquid discharging apparatus for discharging liquid which is used as a precision pipette and serves as a sample. Further more, it may be a liquid discharging apparatus for pinpoint discharging lubricant to precise instruments such as watches or cameras, a liquid discharging apparatus for discharging transparent resin liquid such as UV cured resin or the like for forming a minute semispherical lens (optical lens) or the like used for optical communication elements or the like on a substrate, a liquid discharging apparatus for discharging etching liquid such as acid or alkali for etching substrates or the like, a fluidal substance discharging apparatus for discharging gel, or a fine particle discharging recording apparatus for discharging solid exemplified by fine particles such as toner.

In the printer 1 described in the embodiments above, the fluid is discharged by applying a voltage to the drive element (piezoelectric element) and expanding and contracting an ink chamber. However, the invention is not limited thereto. For example, it may be a printer which generates foams in the nozzles using a heat generating member and discharging the fluid via the foams.

In the embodiments shown above, the printer 1 is a line head printer. However, the invention is not limited thereto. For example, the printer 1 may be a serial printer. In such a case, the head 31 discharges ink on the sheet S while being shifted in the direction of the sheet width (FIG. 2B) during the printing process.

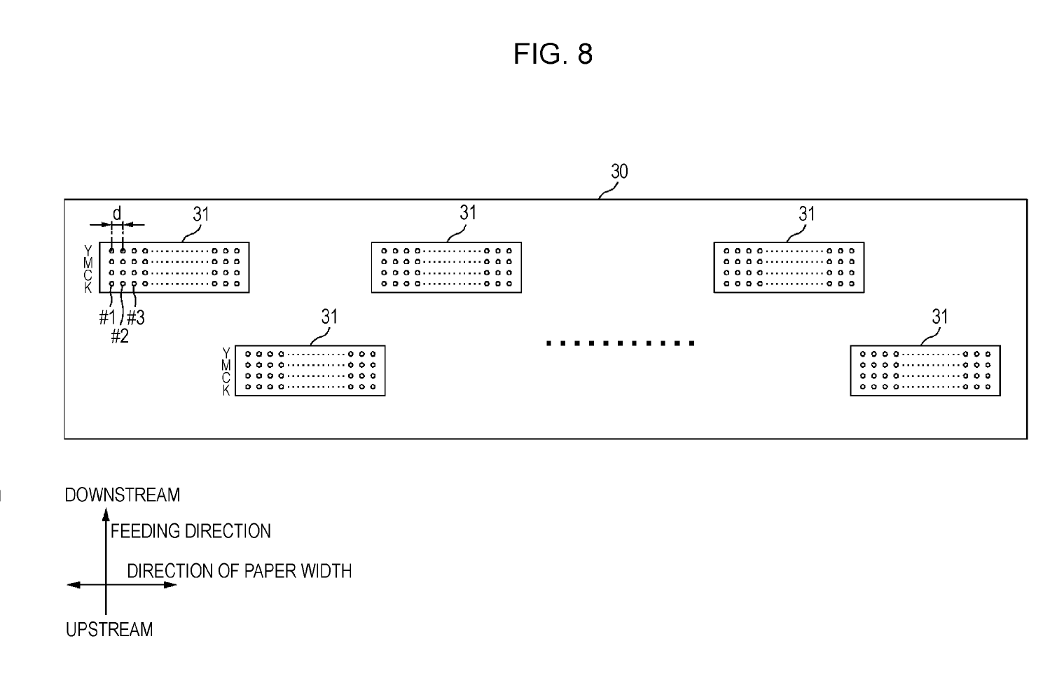

In the embodiments shown above, the head unit 30 includes the single head 31 as shown in FIG. 3, but the invention is not limited thereto. For example, as shown in FIG. 8, the plurality of heads 31 are arranged in a staggered pattern to constitute the head unit 30. Here, the number of nozzles on each head 31 shown in FIG. 8 is smaller than the number of nozzles (n) on the head 31 shown in FIG. 3. FIG. 8 is a drawing showing another embodiment of the head unit 30.

In the embodiments shown above, the pressurizing unit is assumed to be the pressurizing pump 36. However, the invention is not limited thereto. For example, the pressurizing unit may be a mechanism for shifting the ink cartridge 35 in the vertical direction. In such a case, by the ink cartridge 35 being shifted upward by this mechanism, the pressure difference between the ink cartridge 35 and the head 31 is increased and, consequently, the ink may be pressurized.

Furthermore, in the embodiments shown above, the printer 1 is assumed to have the vertical mechanism 28a for shifting the head 31 and the ink receiver 25 with respect to each other so that the ink receiver 25 is selectively positioned at the cleaning position and the waiting position which is farther from the nozzle in comparison with the cleaning position. However, the invention is not limited thereto. For example, the printer 1 may not be provided with the vertical mechanism 28a, and the ink receiver 25 may not be shifted.

However, the embodiments shown above are preferably in that the following effects are achieved. In other words, when the ink receiver 25 is shifted by the vertical mechanism 28a, the ink receiver 25 is shifted to a position so as to close the nozzles, so that the ink discharged from the nozzles is less likely to form a mist. Since the flight distance of the ink is short, even when the ink receiver 25 is small, the ink is easily dropped into the ink receiver 25. Consequently, the ink receiver 25 may be downsized and the discharged ink may still be reliably received in the ink receiver 25.

In the embodiments shown above, the head 31 is assumed to have the four nozzle rows each having n nozzles arranged in a row (FIG. 3). Then, the ink receiver 25 is assumed to be opposed to one of the four nozzle rows without actually contacting the nozzle rows when being at the cleaning position in order to receive the ink pressurized by the pressurizing pump 36 and discharged from the nozzle rows (FIG. 4B). However, the invention is not limited thereto. For example, the ink receiver 25 may be opposed all four nozzle rows simultaneously.

However, when the ink receiver 25 is opposed to the one of the four nozzle rows, the ink discharged from the corresponding nozzle is dropped in the ink receiver 25 in an agglomerated form without being dispersed, so that the ink is effectively collected. Consequently, the embodiments shown above are preferable in that the ink is selectively collected from the four nozzle rows.

In the embodiments shown above, it is assumed that the head 31 is provided at an upper position in the vertical direction, and the ink receiver 25 is provided at a lower position in the vertical direction, and the vertical mechanism 28a sifts the head 31 and the ink receiver 25 with respect to each other in the vertical direction. Also it is assumed that the four nozzle rows are arranged in the feeding direction which intersects the vertical direction. Furthermore, the printer 1 is assumed to have the feeding-direction shifting mechanism 28b for shifting the head 31 and the ink receiver 25 with respect to each other in the feeding direction so that the ink receiver 25 may be positioned at the cleaning position opposing one of the four nozzle rows (FIG. 5A and FIG. 5B). However, the invention is not limited thereto. For example, the printer 1 may not be provided with the feeding-direction shifting mechanism 28b.

However, when the feeding-direction shifting mechanism 28b is provided, the ink receiver 25 is shifted quickly from one nozzle row to another nozzle row when cleaning the four nozzle rows. Consequently, the embodiments shown above are preferably in that the time required for cleaning may be reduced.

In the embodiments shown above, the printer 1 is assumed to have the suction pump 26 (FIG. 4B) for sucking the ink that the ink receiver 25 positioned at the cleaning position receives. However, the invention is not limited thereto. For example, the printer 1 may not be provided with the suction pump 26.

However, the embodiments shown above are preferable in that when the suction pump 26 is provided, ink that the ink receiver 25 receives is sucked and hence accumulation of the ink in the ink receiver 25 is restrained, and leakage of the ink from the ink receiver 25 is prevented even when the ink receiver 25 is small.

Furthermore, in the embodiments shown above, the ink receiver 25 is assumed to be the metallic groove. However, the invention is not limited thereto. For example, the ink receiver 25 may be a resin groove.

However, the embodiments shown above are preferable in that when the ink receiver 25 is formed of metal, the shape accuracy of the groove can easily be secured even when the width of the groove in the direction of the sheet width (FIG. 2B) is large in comparison with the case of the resin, so that the groove opposes the head 31 at a high level of accuracy and, consequently, the ink receiver 25 receives ink more effectively.

What is claimed is:

1. A fluid discharging apparatus comprising:
a head having nozzles capable of discharging fluid supplied to the head;
a storage that stores the fluid to be supplied to the head;
a pressurizing unit that pressurizes the fluid so that the fluid flows from the storage to the head; and
a receiving unit that receives the fluid pressurized by the pressurizing unit and discharged from the nozzle when positioned at a position opposing the nozzles, wherein the receiving unit does not contact the nozzles.

2. The fluid discharging apparatus according to claim 1, further comprising a shifting mechanism for shifting the head and the receiving unit with respect to each other so that the receiving unit may be moved to the position opposing the nozzles.

3. The fluid discharging apparatus according to claim 2, wherein the head includes a plurality of nozzle rows, wherein each row includes a plurality of the nozzles, and the receiving unit opposes one of the plurality of nozzle rows without contacting the nozzle row and receives the fluid discharged from the nozzle rows.

4. The fluid discharging apparatus according to claim 3, wherein the head is provided above the receiving unit in the vertical direction, and the shifting mechanism shifts the head and the receiving unit with respect to each other in the vertical direction, wherein the plurality of nozzle rows in the head are arranged in an array in the horizontal direction, and a second shifting mechanism shifts the head and the receiving unit with respect to each other in the horizontal direction so that the receiving unit may be positioned so as to selectively oppose each of the plurality of nozzle rows.

5. The fluid discharging apparatus according to claim 2, further comprising a suction member that is capable of removing the fluid received by the receiving unit.

6. The fluid discharging apparatus according to claim 1, wherein the receiving unit is a metallic groove.

7. A fluid discharging method comprising:
pressurizing a fluid stored in a storage;
discharging the pressurized fluid from a plurality of nozzles provided on a head;
collecting the discharged fluid in a receiving unit which is capable of receiving the discharged fluid without contacting the nozzles.

8. A fluid discharging apparatus comprising:
a head having nozzles capable of discharging fluid supplied to the head;
a storage that stores the fluid to be supplied to the head;
a pressurizing unit that pressurizes the fluid so that the fluid flows from the storage to the head;
a receiving unit that is capable of receiving the fluid discharged from the nozzle when positioned at a position opposing the nozzles, wherein the receiving unit does not contact the nozzles;
a positioning unit capable of moving the receiving unit into the position opposing the nozzles; and
a suction member that is capable of removing the fluid received by the receiving unit.

9. The fluid discharging apparatus according to claim 8, wherein the head includes a plurality of nozzle rows, wherein each row includes a plurality of the nozzles, and the receiving unit opposes one of the plurality of nozzle rows without contacting the nozzle row and receives the fluid discharged from the nozzle rows.

10. The fluid discharging apparatus according to claim 8, wherein the head is provided above the receiving unit in the vertical direction, and the shifting mechanism shifts the head and the receiving unit with respect to each other in the vertical direction, wherein the plurality of nozzle rows in the head are arranged in an array in the horizontal direction, and a second shifting mechanism shifts the head and the receiving unit with respect to each other in the horizontal direction so that the receiving unit may be positioned so as to selectively oppose each of the plurality of nozzle rows.

11. The fluid discharging apparatus according to claim 8, wherein the receiving unit is a metallic groove.
